(19) United States
(12) Patent Application Publication
(10) Pub. No.: US 2019/0235526 A1
(43) Pub. Date: Aug. 1, 2019

(54) METHOD FOR CONTROLLING MOVABLE DEVICE, CONTROL SYSTEM, AND MOVABLE DEVICE

(71) Applicant: SZ DJI TECHNOLOGY CO., LTD., Shenzhen (CN)

(72) Inventor: Chaobin CHEN, Shenzhen (CN)

(21) Appl. No.: 16/380,330

(22) Filed: Apr. 10, 2019

Related U.S. Application Data
(63) Continuation of application No. PCT/CN2016/102526, filed on Oct. 19, 2016.

(51) Int. Cl. G05D 1/08; G05D 1/00

(52) U.S. Cl. CPC G05D 1/08; B64C 39/024; G05D 1/0011

(57) ABSTRACT

A method for controlling a movable device includes obtaining topology information of a travel path traversed by the movable device in response to losing a control signal. The method also includes controlling the movable device to travel based on the topology information and searching for the control signal.

### CROSS-REFERENCE TO RELATED APPLICATION

This application is a continuation application of International Application No. PCT/CN2016/102526, filed on Oct. 19, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of controls and, more particularly, to a method for controlling movable devices, a control system, and a movable device.

### BACKGROUND

Most unmanned aerial vehicles (“UAV”) available on the market are controlled by remote control devices. A receiver provided in the UAV receives the signals from a remote control device, and transmits the signals to a flight control system. The flight control system converts the signals into control instructions for controlling various flight operations and functions of the UAV.

When the UAV cannot receive the signals from the remote control device (i.e., out of control), to ensure flight safety, the UAV may take emergency strategies such as returning flight, landing, or hovering (or suspending) in the air. However, these emergency strategies may pose some safety issues under certain circumstances. For example, when the UAV is not provided with an obstacle avoidance function, then in the return flight when the UAV is out of control, the UAV may collide with other objects, or may directly land and fall into a body of water.

For other movable devices, such as unmanned boats (or ships) or robots, the safety issues when these movable devices are out of control still need to be addressed.

Therefore, there is a need to solve the technical problems associated with enhancing the safety when a movable device is out of control.

### SUMMARY

In accordance with the present disclosure, there is provided a method for controlling a movable device. The method includes obtaining topology information of a travel path traversed by the movable device in response to losing a control signal. The method also includes controlling the movable device to travel based on the topology information and searching for the control signal.

In accordance with the present disclosure, there is also provided a movable device. The movable device includes an acquisition device configured to obtain topology information of a travel path traversed by the movable device in response to losing a control signal. The movable device also includes a movement device configured to control the movable device to travel based on the topology information. The movable device further includes a searching device configured to search for the control signal while the movement device controls the movable device to travel based on the topology information.

In accordance with the present disclosure, there is further provided a movable device including a propulsion system and a control system. The control system includes a storage device configured to store computer-executable instructions. The control system also includes a processor configured to access the storage device and execute the computer-executable instructions to perform a method for controlling the movable device. The method includes obtaining topology information of a travel path traversed by the movable device in response to losing a control signal. The method also includes controlling the movable device to travel based on the topology information and searching for the control signal.

The methods for controlling movable devices, the control systems, and the movable devices of the present disclosure can increase the likelihood of restoring the control signals for controlling the movable devices, reduce the out of control time, reduce the risk caused by the loss of the control, and enhance the safety when the movable device is out of control.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram of the structure of an unmanned aerial vehicle according to an example embodiment.

FIG. 2 is a flow chart illustrating a method for controlling a movable device according to an example embodiment.

FIG. 3 is a flow chart illustrating a method for controlling a movable device according to another example embodiment.

FIG. 4 is a schematic diagram of topology information according to an example embodiment.

FIG. 5 is a schematic diagram of topology information according to another example embodiment.

FIG. 6 is a schematic diagram of topology information according to another example embodiment.

FIG. 7 is a schematic diagram of topology information according to another example embodiment.

FIG. 8 is a schematic diagram of topology information according to another example embodiment.

FIG. 9 is flow chart illustrating a method for controlling a movable device according to another example embodiment.

FIG. 10 is a schematic diagram of a control system according to an example embodiment.

FIG. 11 is a schematic diagram of a movable device according to an example embodiment.

FIG. 12 is a schematic diagram of a movable device according to another example embodiment.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed. The term “communicatively coupled” indicates that related items are coupled or connected through a communication chancel, such as a wired or wireless communication channel.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The technical solutions of the present disclosure can be implemented in various movable devices. A movable device may be controlled by an external control signal (e.g., a control signal receiving from a device external to the movable device) to travel (or move). For example, the movable device may be a UAV, an unmanned boat (or ship or submarine), or a robot, etc. The present disclosure is not limited to these types of movable devices. The movable devices may be any remote controllable movable devices. For discussion purposes, the following descriptions use UAV as an example of the movable device. For a UAV, the movement (or travel) of the movable device is flying.

The external control signals may be provided by a remote control device, a ground terminal, a base station, an application, a computer, or any other movable device that is configured to transmit a control signal. The present disclosure does not limit the source of the external control signals. For discussion purposes, below descriptions use a remote control device as an example of the source for providing the external control signals.

Unmanned aerial vehicles of the present disclosure can include various types of UAVs. For example, the UAVs can be small UAVs, multi-rotor UAVs, etc. The present disclosure does not limit the types of UAVs. In some embodiments, multi-rotor UAVs may also be referred to as rotorcrafts.

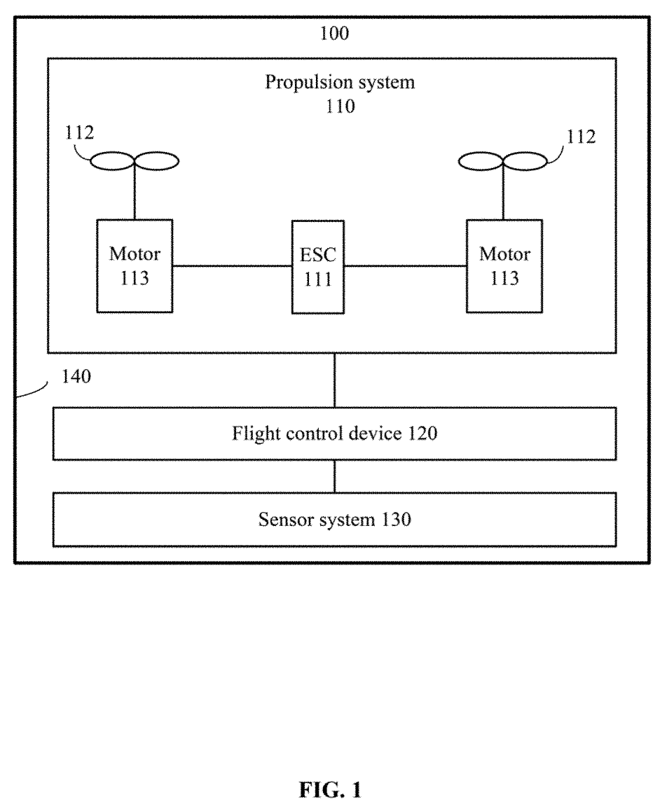

FIG. 1 is a schematic diagram of the structure of a UAV 100. This embodiment uses a multi-rotor UAV as an example to describe the disclosed features.

As shown in FIG. 1, the UAV 100 may include a propulsion system 110, a flight control device 120, a sensor system 130, and a frame 140.

The propulsion system 110 may include an electrical speed control (“ESC”) 111, two or more propellers 112, and two or more motors 113 corresponding to the two or more propellers 112. FIG. 1 only shows two propellers 112 and two corresponding motors 113. The present disclosure does not limit the number of the propellers 112 and the motors 113. Each motor 113 may be disposed between the ESC 111 and each propeller 112. The motor 113 and the propeller 112 may be mounted on a corresponding arm. The ESC 111 may be configured to receive a driving signal generated by the flight control device 120, and provide an electric current to the motor 113 based on the driving signal to control a rotation speed of the motor 113. The motor 113 may be configured to drive the propeller 112 to rotate, thereby providing propulsion forces for the flight of the UAV 100.

In some embodiments, the sensor system 130 may be configured to measure, sense, or detect attitude information regarding the UAV 100, including, for example, position information and status information in a space, such as three-dimensional positions, three-dimensional angles, three-dimensional velocity, three-dimensional acceleration, and three-dimensional angular velocity, etc. The sensor system 130 may include at least one of a gyroscope, an electric compass, an inertial measurement unit (“IMU”), a visual sensor, a global positioning system (“GPS”), a barometer, or an airspeed meter, etc.

The flight control device 120 may be configured to control the flight of the UAV 100. In some embodiments, the flight control device 120 may control the flight of the UAV 100 according to pre-programmed codes or instructions. For example, the flight control device 120 may control the flight of the UAV 100 based on the attitude information measured by the sensor system 130. In some embodiments, the flight control device 120 may control the UAV 100 based on control signals received from a remote control device.

In some embodiments, the frame 140 may include a body and a supporting leg frame (or landing gear). The body may include a central frame and one or more arms connected with the central frame. The one or more arms may radially extend from the central frame. The supporting leg frame is connected with the body, and configured to support the UAV 100 during and after landing.

A person having ordinary skill in the art can appreciate that the names of the various components of the UAV 100 are only for the convenience of identification, and are not intended to limit the scope of the present disclosure.

A person having ordinary skill in the art can appreciate that the UAV 100 may include other components, elements, members, units, or devices that are not shown in FIG. 1, such as an imaging device. The present disclosure does not limit the UAV 100 to include only those elements shown in FIG. 1.

In some embodiments, the UAV 100 may fly based on control signals received from a remote control device. For example, the flight control device 120 may control the UAV 100 based on control signals received from the remote control device. When the UAV 100 cannot receive (e.g., loses) the control signals from the remote control device, i.e., when the UAV 100 is out of control, the UAV 100 may fly based on predetermined strategies, such as returning flight, landing, or hovering (or suspending) in the air, etc. These strategies, however, may pose safety issues under certain circumstances.

In most situations, the UAV loses control signals from the remote control device because the control signals are blocked by obstacles, or because the flight distance is too far. Under such circumstances, if the UAV performs a searching flight based on the original flight path, it is possible that the control of the UAV by the remote control device can be restored (by restoring the control signals), and the UAV does not need to return flight, land, or hover.

According to the technical solutions of the present disclosure, when the movable devices, such as UAVs, are out of control, the movable devices may travel (or move) along the original travel path and search for control signals in the meantime. In this manner, the likelihood of restoring the control signals is increased, thereby enhancing the safety of the movable device when the movable device is out of control.

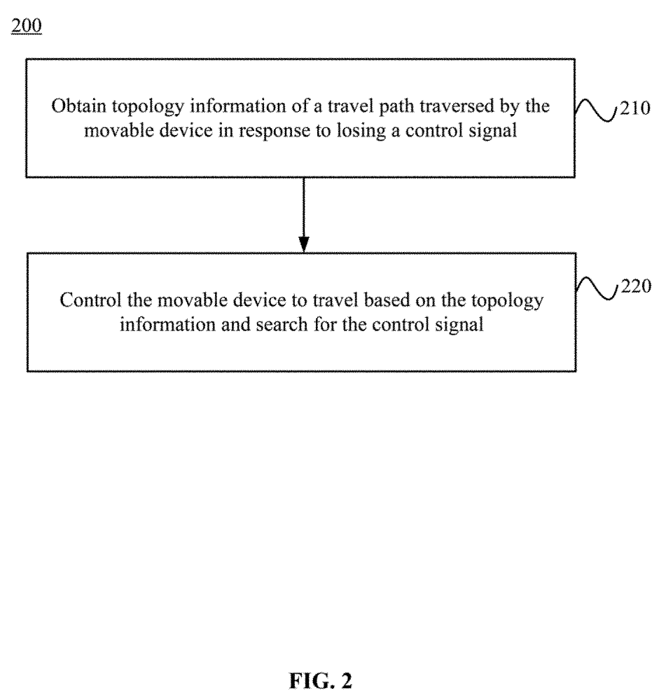

FIG. 2 is a flow chart illustrating a method 200 for controlling a movable device. The method 200 may be executed by the movable device. For example, the method 200 may be executed by a control system included in the movable device. In some embodiments, when the movable device is a UAV, the method 200 may be executed by a flight control device included in the UAV.

As shown in FIG. 2, the method 200 includes:

Step 210, obtaining topology information of a travel path traversed by the movable device in response to losing a control signal; and

Step 220, controlling the movable device to travel based on the topology information and searching for the control signal.

According to the present disclosure, when detecting that the movable device has lost the control signal, i.e., when the movable device is out of control, the movable device may be controlled to travel based on the topology information of a travel path already traversed by the movable device, and search for the control signal in the meantime. When traveling based on the topology information, the movable device may arrive at a location where the movable device once reached or travelled by. Therefore, the likelihood for the movable device to search and receive the control signal is enhanced. When receiving the control signal again, the control of the movable device based on the control signal can be restored.

As such, the method for controlling the movable device disclosed in the present disclosure can increase the likelihood of restoring the control signals for controlling the movable devices, reduce the out of control time, reduce the risk caused by the loss of the control, and enhance the safety when the movable device is out of control.

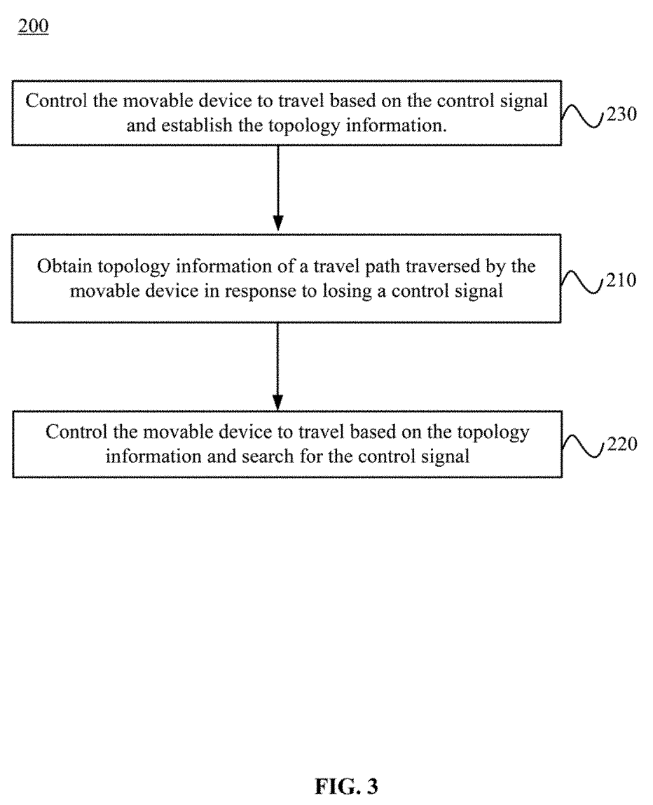

In some embodiments, the topology information may be established during movement (or travel) of the movable device prior to losing the control signal. As shown in FIG. 3, prior to losing the control signal, the method 200 may further include:

Step 230, controlling the movable device to travel based on the control signal and establishing the topology information.

In some embodiments, prior to losing the control signal, the movable device may travel based on the control signal, and establish the topology information in the meantime. The topology information indicates the travel path traversed by the movable device. The present disclosure does not limit the format of the topology information and the methods for establishing the topology information. The movable device may establish any information relating to the travel path traversed by the movable device. A number of methods for establishing the topology information are described below.

Optionally, in an embodiment of the present disclosure, the topology information may include a trajectory traversed by the movable device.

Specifically, in this embodiment, the topology information includes the trajectory traversed by the movable device. While the movable device travels based on the control signal, the movable device may record or store, in real time, the trajectory traversed. If there is a limit on the size of the topology information the movable device can store, the trajectory saved (or stored) can be the most recent (or last) trajectory in the past predetermined period of time. Because the precision of the trajectory may be high, the topology information of a limited size may cover a small region or area.

In some embodiments, the topology information may include vertices and legs. A vertex may represent a location at which the movable device arrived, and a leg may represent a line between two vertices.

In some embodiments, in order to enlarge the region or area covered by the topology information of a limited size, the topology information may take the form of vertices and legs. The method for establishing the topology information is described below.

In some embodiments, establishing the topology information may include establishing an initial vertex based on an initial travel location of the movable device.

In some embodiments, establishing the topology information may include establishing a new vertex and a new leg based on an influence region (or area) of a vertex that has been established.

Specifically, in one embodiment, establishing the topology information may include establishing a new vertex and a new leg based on an influence region of a vertex that has been established. For example, the influence region may be a spherical region that uses the vertex as a center point, and a predetermined distance as a radius.

A person having ordinary skill in the art can appreciate that the size of the influence region may be pre-set based on specific application needs. In addition, the influence region is not limited to a spherical region. The influence region may be regions of other shapes.

In some embodiments, a first vertex, i.e., the initial vertex, may be an initial travel location. The initial travel location may be a location when the movable device starts to establish the topology information. In some embodiments, the movable device may start establishing the topology information when a predetermined condition is satisfied. For example, for a UAV, the predetermined condition may include: precision of positioning is sufficient (e.g., greater than a predetermined precision threshold), the UAV is flying in the air, etc.

In some embodiments, after establishing a first vertex, the movable device may establish a second vertex and corresponding one or more legs based on an influence region of the first vertex.

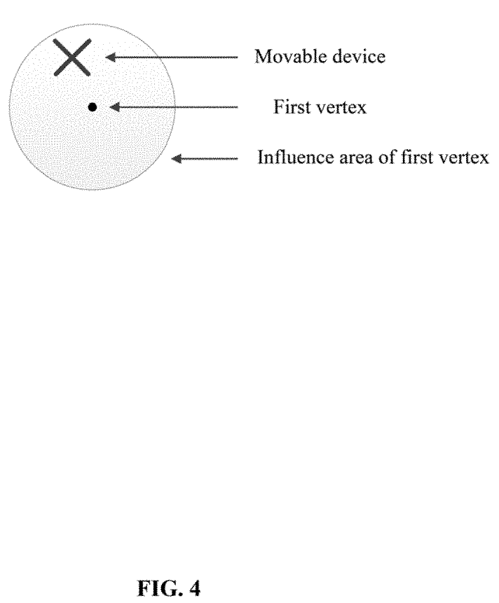

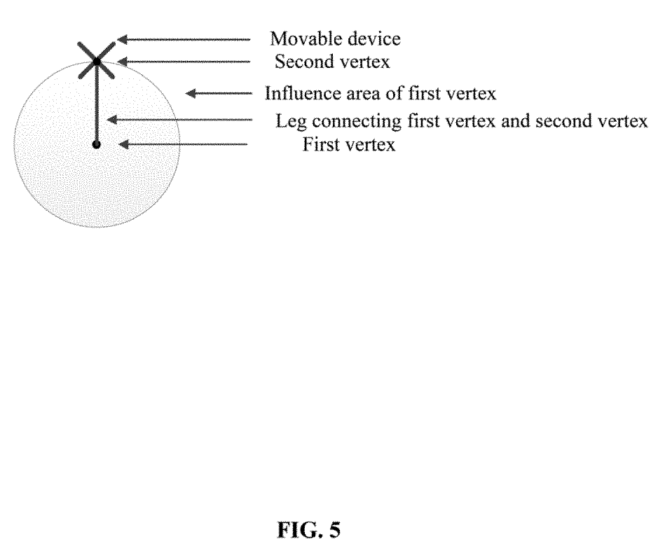

As shown in FIG. 4, as long as the movable device does not travel out of the influence region of the current vertex, the movable device may not establish a new vertex. As shown in FIG. 5, when the movable device arrives at a boundary of an influence region of a first vertex, the movable device may establish a second vertex and one or more legs connecting the first vertex and the second vertex. Subsequently, as long as the movable device does not travel out of the influence region of the second vertex, the movable device may not establish a new vertex.

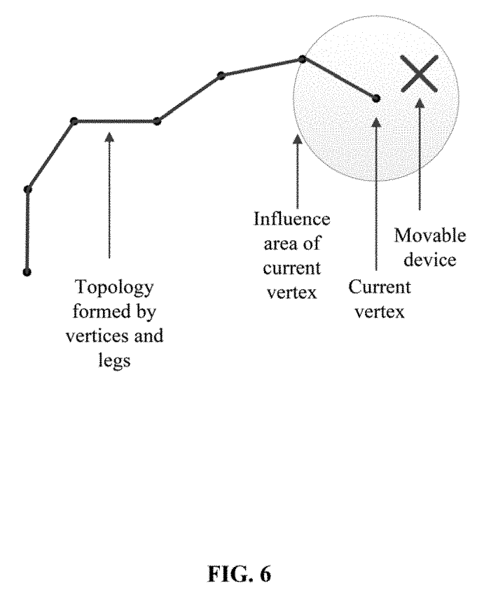

New vertices may be established in a similar manner. Finally, a topology graph with topology information may be established, as shown in FIG. 6.

In some embodiments, when the movable device is located in influence regions of multiple vertices, the movable device may determine that it is located within an influence region whose corresponding vertex is located closest to the movable device.

In other words, when establishing the topology information, the influence region in which the movable device is located is determined based on the vertex that is closest to the movable device.

In some embodiments, the movable device may delete an oldest vertex (e.g., a vertex that is established at the earliest time) and one or more legs connected with the oldest vertex prior to establishing a new vertex, based on a determination that a number of vertices included in the topology information has reached a predetermined value.

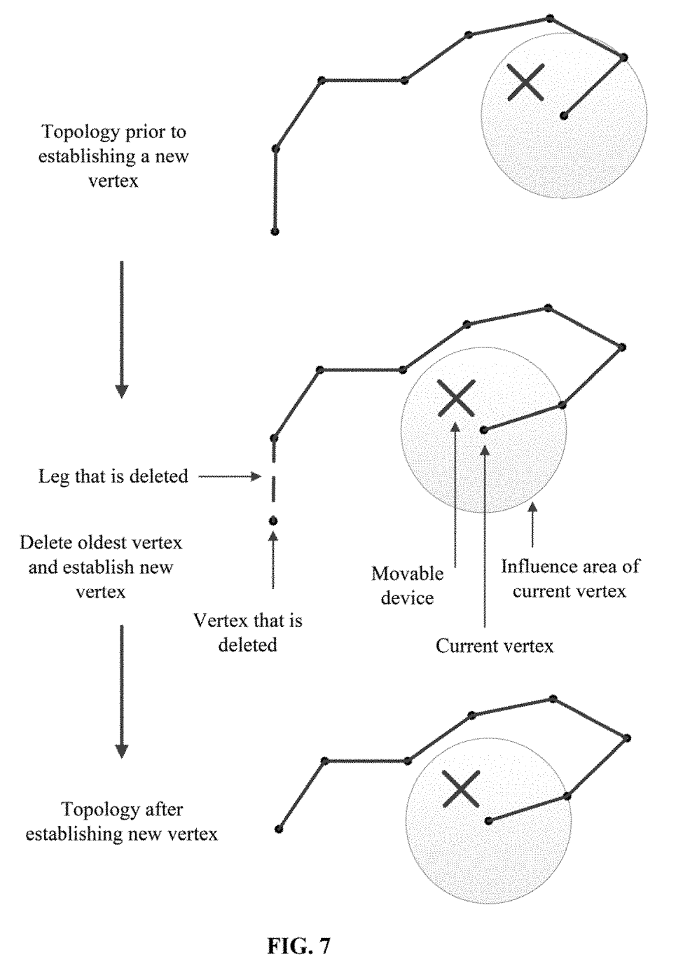

In some embodiments, if the movable device can only store topology information of a limited size, when the stored number of vertices has reached a predetermined value limited by a storage capacity, as shown in FIG. 7, prior to establishing a new vertex, the movable device may delete the oldest vertex, which is the vertex that was established at the earliest time among the vertices included in the topology information. The movable device may delete one or more legs connecting the oldest vertex and other vertices. After the deletion, the movable device may then create the new vertex and one or more new legs connecting the new vertex to one or more other vertices.

In some embodiments, when the movable device travels from an influence region of a third vertex into an influence region of a fourth vertex, and when there is no leg connecting the third vertex and the fourth vertex, the movable device may establish the leg connecting the third vertex and the fourth vertex.

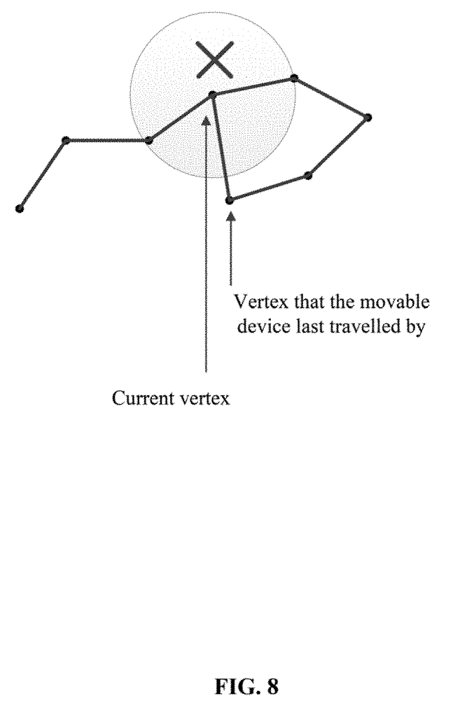

For example, as shown in FIG. 8, the movable device has travelled from an influence region of an already established vertex into an influence region of another already established vertex, and there is no leg connecting the two vertices, the movable device may establish a leg connecting the two vertices.

In some embodiments, the movable device may delete the topology information based on a determination that a predetermined condition has not been satisfied. The movable device may wait until the predetermined condition has been satisfied before starting to establish the topology information. For example, for a UAV, the predetermined condition may include: the precision of positioning is sufficient (e.g., greater than a predetermined precision threshold), the UAV is flying in the air, etc. For example, when the precision of positioning is insufficient (e.g., not greater than the predetermined precision threshold), or when the UAV is not flying in the air, the UAV may delete all of the stored topology information. The UAV may wait until the precision of positioning is sufficient and the UAV is in flight in the air, the UAV may then start establishing the topology information.

In some embodiments, the topology information may include grid point. The grid point may indicate that the movable device was once in an area in which the grid point is located.

In some embodiments, the topology information may take the form of grid points. When establishing the topology information, the movable device may divide the three-dimensional space into a grid. Each grid point may represent an area in the grid. When the movable device arrives at an area in which the grid point is located, the grid point may be recorded or included in the topology information. In this manner, all of the grid points included in the topology information may represent information relating to the travel path traversed by the movable device.

In some embodiments, the above-described forms of topology information and methods for establishing the topology information are examples only, and do not limit the scope of the present disclosure.

In some embodiments, when the movable device can receive a control signal, the movable device may travel based on the control signal, and may establish topology information during the movement. In response to losing the control signal, the movable device may be controlled to travel based on the topology information and search for the control signal during the movement (e.g., travel). The processes for dealing with the situations when the movable device loses the control signals will be described below.

In some embodiments, in response to losing the control signal e, the movable device may determine a travel path based on the topology information, and may be controlled to travel along the travel path.

For example, when the movable device is out of control, the movable device may determine a subsequent travel path for the subsequent movement based on the topology information that has been established previously. The movable device may be controlled to travel along the travel path, and search for the control signal in the meantime.

Using a UAV as an example, when the UAV is out of control because the control signal is lost and when the UAV has activated an out-of-control searching function, the UAV may search for a path based on the already established topology information, and may conduct a search for the control signal while flying along the path. If during the flight while searching for the control signal, the UAV restores the control by the control signals (e.g., the UAV receives the control signals again), the UAV may exit the out-of-control searching function.

The present disclosure does not limit the method for selecting a travel path for subsequent movement (or travel). The travel path for subsequent movement may be any suitable path, or a path that satisfies a predetermined condition.

In some embodiments, the travel path may satisfy at least one of the following:

the travel path is the shortest;

a cost associated with the traveling along the travel path is the lowest; or

the travel path leads to a returning point, the returning point representing a starting point of the movable device or representing a predetermined return location.

In some embodiments, the travel path may be the shortest path. For example, the travel path may be a shortest path formed by the vertices and/or legs included in the topology information. In some embodiments, the travel path may be a path whose cost associated with traveling along the path is the lowest. In some embodiments, the cost may include expenses calculated based on certain factors. For example, the factors may include a power consumption amount, a likelihood of encountering an obstacle, etc. The present disclosure does not limit the factors for calculating the cost. In some embodiments, the travel path may be a path leading to a returning point. For example, for a UAV, the travel path may be a path leading to a returning flight point. In some embodiments, the returning point may be a pre-set returning location. For example, the pre-set returning location may be one or more safe returning locations.

In some embodiments, when the topology information includes the vertices and the legs, the travel path may cover all or a portion of the legs included in the topology information.

In some embodiments, when the topology information includes the vertices and legs, and when the UAV loses the control signals, the movable device may select a leg from a plurality of legs connected with the vertex based on the topology information, and may be controlled to travel based on the selected leg.

In some embodiments, the movable device does not select an entire travel path at one time, but rather, select the travel path step by step. For example, when the movable device arrives at a vertex, the movable device may select a leg from a plurality of legs connected with the vertex as the travel path for the next step. In some embodiments, when selecting a leg from a plurality of legs connected with the vertex, the selection may be arbitrary, or may be based on a predetermined strategy. The leg may be selected from all or some of the legs connected with the vertex.

In some embodiments, the selected leg may be a leg connecting the current vertex and another vertex that the movable device last travelled by (e.g., arrived at most recently). In some embodiments, the selected leg may be a leg connecting the current vertex and a vertex that is closest to the returning point. The returning point may indicate the starting point of the movable device or a predetermined returning location.

The above describes two methods for selecting an entire travel path at one time and selecting the travel path step by step. In some embodiments, these methods may be combined. For example, a portion of the travel path may be determined, which may be traversed while searching for the control signals, and then the subsequent portion of the travel path may be determined step by step.

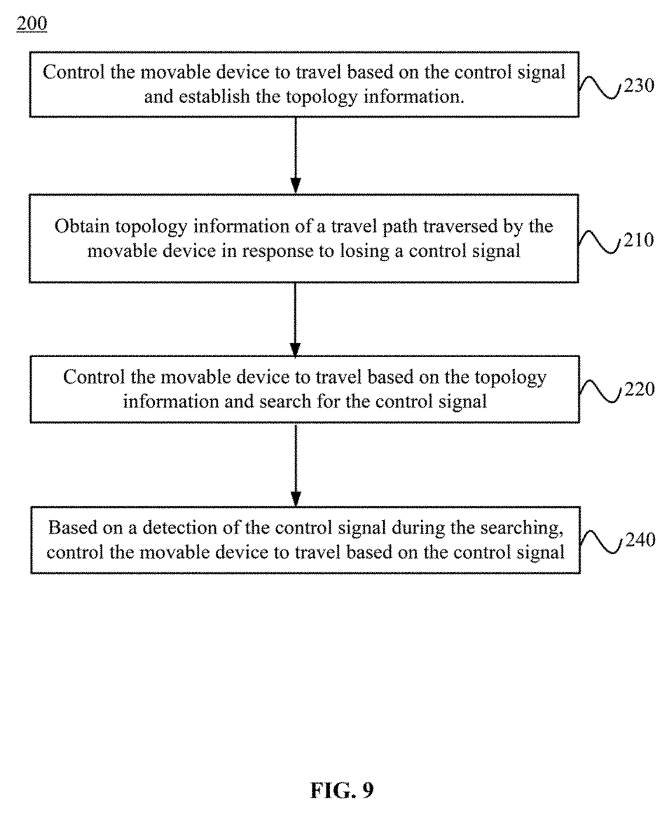

In some embodiments, as shown in FIG. 9, the method 200 may also include:

Step 240, based on a detection of the control signal during the searching, controlling the movable device to travel based on the control signal.

In some embodiments, when the movable device is out of control, the movable device may be controlled to travel in the above-described manner and search for the control signal. Once the movable device detects the control signal during the search, the movable device may restore the control based on the control signal, and terminate (or stop) the search for the control signal. That is, the movable device may restore a normal control mode controlling the travel of the movable device based on the control signal. The movable device may continue to travel under the control of the control signal.

In some embodiments, the movable device may terminate the search for the control signal when at least one of the following is satisfied:

the control signal is detected during the search;

the topology information has been deleted;

an abnormal condition occurred in a system of the movable device; for example, an abnormal condition occurred in the sensor system of the movable device, the movable device detects an obstacle, a power level in a battery of the movable device is low, etc.

the movable device cannot travel based on the topology information; for example, the movement (or travel) of the movable device deviated more than a predetermined amount from the topology information due to certain reasons, such as due to the blow of a strong wind, etc.; or

the search for the control signal has been performed for a predetermined number of times.

In some embodiments, the search is deemed to have been performed for one time when at least one of the following is performed:

a predetermined path has been searched;

a predetermined distance has been searched;

all of the legs included in the topology information has been searched;

a predetermined amount of time has been searched for.

In some embodiments, based on a detection of the control signal during the search, the movable device may terminate the search. In some embodiments, if after performing the search for one time, the movable device still has not detected the control signal, the movable device may continue the search or may terminate the search. Searching for one time may be deemed to have been performed when any of the above listed criteria is satisfied. Other criteria may also be used to define a search for one time. The number of searches may be predetermined based on needs, and the present disclosure does not limit the number of searches or the criteria for defining the search.

According to the methods for controlling the movable device of the present disclosure, the movable device may establish topology information prior to losing the control signal (e.g., prior to being out of control). After the movable device loses the control signal (e.g., after the movable device becomes out of control), the movable device may be controlled to travel based on the topology information previously established and search for the control signal while travelling. The disclosed method can increase the likelihood of restoring the control signals for controlling the movable device, reduce the out of control time, reduce the risk caused by the loss of the control, and enhance the safety when the movable device is out of control.

A person having ordinary skill in the art can appreciate that the reference numbers for the steps of the disclosed methods do not indicate the actual sequence of execution of the steps. The execution of the steps may be determined based on the functions and internal logic. The present disclosure does not limit the sequence of the execution of the steps or the implementation process of the disclosed methods.

The above describes the methods for controlling the movable device. Embodiments of the control system and the movable devices will be described below.

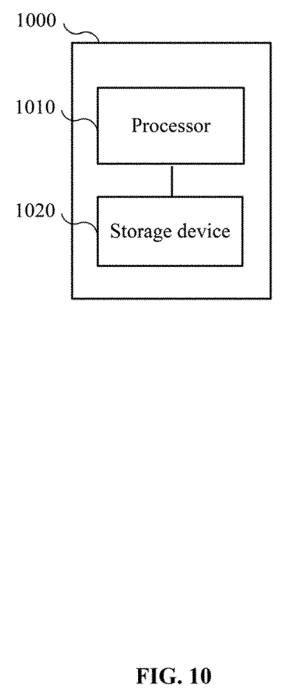

FIG. 10 is a schematic diagram of a control system 1000. The control system 1000 may be included in a movable device. For example, the control system 1000 may be included in the flight control device 120 of the UAV 100 shown in FIG. 1.

As shown in FIG. 10, in some embodiments, the control system 1000 may include a processor 1010 and a storage device 1020.

The storage device 1020 may be configured to store computer-executable instructions.

The storage device 1020 may include any suitable type of storage devices. The present disclosure does not limit the type of storage devices to be included in the storage device 1020.

The processor 1010 may be configured or programmed to access the storage device 1020 (e.g., retrieve or read the computer-executable instructions), and may execute the computer-executable instructions to perform the method for controlling the movable device, as disclosed in the present disclosure.

The processor 1010 may include any suitable type of processors. The present disclosure does not limit the type of processors for the processor 1010.

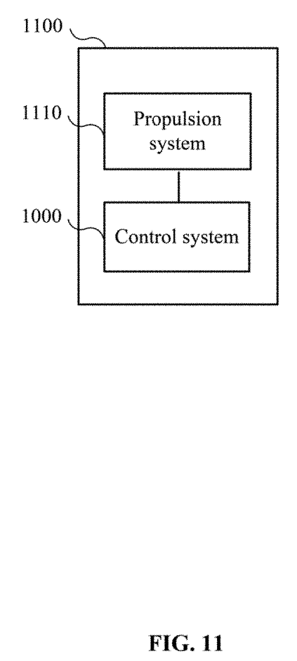

FIG. 11 is a schematic diagram of a movable device 1100. The movable device 1100 may be a UAV (e.g., UAV 100 of FIG. 1), an unmanned boat or ship, or a robot, etc.

As shown in FIG. 11, the movable device 1100 may include:

a propulsion system 1110 configured to provide a propulsion force for the movable device 1100; and

the control system 1000 described above. The control system 1000 may be configured to transmit instructions or signals to the propulsion system 1110 to control the movable device 1100.

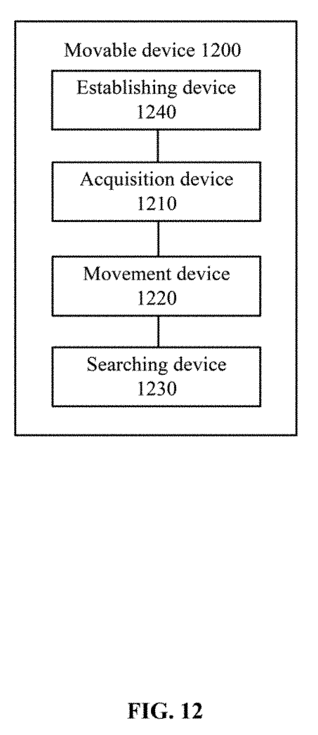

FIG. 12 is a schematic diagram of another example movable device 1200. The movable device 1200 may be configured to execute the above-described methods for controlling the movable device. The movable device 1200 may be a UAV (e.g., UAV 100 of FIG. 1), an unmanned boat or ship, or a robot, etc. In some embodiments, each of the devices included in the movable device 1200, as shown in FIG. 12, may include a processor configured to perform some or all of the disclosed methods or steps. In some embodiments, the devices 1210-1240 listed in movable device 1200 may be included in a processor as different parts configured to perform some or all of the disclosed methods or steps.

As shown in FIG. 12, the movable device 1200 may include:

an acquisition device 1210 configured to obtain topology information of a travel path traversed by the movable device in response to losing a control signal;

a movement device 1220 configured to control the movable device to travel based on the topology information; and

a searching device 1230 configured to search for the control signal while the movement device controls the movable device to travel based on the topology information.

The movable device of the present disclosure can increase the likelihood of restoring the control signals for controlling the movable device, reduce the out of control time, reduce the risk caused by the loss of the control, and enhance the safety when the movable device is out of control.

In some embodiments, as shown in FIG. 12, the movable device 1200 may include:

an establishing device 1240 configured to establish the topology information prior to losing the control signal.

In some embodiments, the topology information may include vertices and legs. A vertex may represent a location at which the movable device arrived, and a leg may represent a line connecting two vertices.

In some embodiments, the establishing device 1240 may be configured to establish an initial vertex based on an initial travel location of the movable device; and establish a new vertex and a new leg based on an influence region of a vertex that has been established. The influence region may be a predetermined region having the vertex as a center point.

In some embodiments, the establishing device 1240 may be configured to establish a second vertex and establish one or more legs connecting the first vertex and the second vertex when the movable device arrives at a boundary of an influence region of a first vertex.

In some embodiments, when the movable device is located in influence regions of multiple vertices, the establishing device 1240 may be configured to determine that the movable device is located within an influence region whose corresponding vertex is located closest to the movable device.

In some embodiments, when the movable device travels from an influence region of a third vertex into an influence region of a fourth vertex, and when there is no leg connecting the third vertex and the fourth vertex, the establishing device 1240 may be configured to establish the leg connecting the third vertex and the fourth vertex.

In some embodiments, the establishing device 1240 may be configured to delete an oldest vertex and one or more legs connected with the oldest vertex prior to establishing a new vertex, based on a determination that a number of vertices included in the topology information has reached a predetermined value.

In some embodiments, the topology information may include a trajectory traversed by the movable device.

In some embodiments, the movement device 1220 may be configured to determine a travel path based on the topology information; and control the movable device to travel along the travel path.

In some embodiments, the travel path may satisfy at least one of the following:

the travel path is the shortest;

a cost associated with the traveling along the travel path is the lowest; or

the travel path leads to a returning point, the returning point representing a starting point of the movable device or representing a predetermined return location.

In some embodiments, when the topology information includes the vertices and the legs, the travel path may cover all or a portion of the legs included in the topology information.

In some embodiments, the movement device 1220 may be configured to select a leg from a plurality of legs connected with a current vertex based on the topology information; and control the movable device to travel based on the selected leg.

In some embodiments, the selected leg is a leg connecting the current vertex and a vertex that the movable device last travelled by.

In some embodiments, the selected leg is a leg connecting the current vertex and a vertex that is closest to a returning point. The returning point may indicate a starting point of the movable device or a predetermined returning location.

In some embodiments, based on a detection of the control signal during the search, the movement device 1220 may be configured to control the movable device to travel based on the control signal.

In some embodiments, the searching device 1230 may be configured to terminate the search for the control signal when at least one of the following is satisfied:

the control signal is detected during the search;

the topology information has been deleted;

an abnormal condition occurred in a system of the movable device;

the movable device cannot travel based on the topology information; or

the search for the control signal has been performed for a predetermined number of times.

In some embodiments, the control signal may be a control signal transmitted by a remote control device, a ground terminal, a base station, an application, a computer, or any other movable device that is configured to transmit a control signal.

The control system and the movable device of the present disclosure can execute the disclosed methods for controlling the movable device. The components, devices, units, modules, and/or elements included in the control system and the movable device are configured to perform the operations and/or functions of the corresponding steps of the various methods disclosed herein. For simplicity, the descriptions of the operations and/or functions performed by the various components, devices, units, modules, and/or elements of the control system and the movable device can further refer to the descriptions of the methods.

The present disclosure provides a non-transitory computer storage medium configured to store program codes or instructions. The program codes or instructions may be executed to instruct various devices, systems, or components to perform the disclosed methods for controlling the movable device.

A person having ordinary skill in the art can appreciate that the above embodiments are only examples of the present disclosure, which are described for the better understanding of the present disclosure, and do not limit the scope of the present disclosure.

A person having ordinary skill in the art can appreciate that when the term “and/or” is used, the term describes a relationship between related items. The term “and/or” means three relationships may exist between the related items. For example, A and/or B can mean A only, A and B, and B only. The symbol “/” means “or” between the related items separated by the symbol.

A person having ordinary skill in the art can appreciate that part or all of the above disclosed methods and processes may be implemented using related electrical hardware, computer software, or a combination of electrical hardware and computer software that may control the electrical hardware. To illustrate the exchangeability of the hardware and software, in the above descriptions, the configurations and steps of the various embodiments have been explained based on the functions performed by the hardware and/or software. Whether the implementation of the functions is through hardware or software is to be determined based on specific application and design constraints. A person having ordinary skill in the art may use different methods to implement the functions for different applications. Such implementations do not fall outside of the scope of the present disclosure.

A person having ordinary skill in the art can appreciate that descriptions of the functions and operations of the system, device, and unit can refer to the descriptions of the disclosed methods.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. Some or all of the units or components may be selected to implement the disclosed embodiments based on the actual needs of different applications.

Various functional units or components may be integrated in a single processing unit, or may exist as separate physical units or components. In some embodiments, two or more units or components may be integrated in a single unit or component.

If the integrated units are realized as software functional units and sold or used as independent products, the integrated units may be stored in a computer-readable storage medium. Based on such understanding, the portion of the technical solution of the present disclosure that contributes to the current technology, or some or all of the disclosed technical solution may be implemented as a software product. The computer software product may be storage in a non-transitory storage medium, including instructions or codes for causing a computing device (e.g., personal computer, server, or network device, etc.) to execute some or all of the steps of the disclosed methods. The storage medium may include any suitable medium that can store program codes or instruction, such as at least one of a U disk (e.g., flash memory disk), a movable hard disk, a read-only memory (“ROM”), a random access memory (“RAM”), a magnetic disk, or an optical disc.

The above descriptions only illustrate some embodiments of the present disclosure. The present disclosure is not limited the described embodiments. A person having ordinary skill in the art may conceive various equivalent modifications or replacements based on the disclosed technology. Such modification or improvement also fall within the scope of the present disclosure. A true scope and spirit of the present disclosure are indicated by the following claims.

What is claimed is:

1. A method for controlling a movable device, comprising:
obtaining topology information of a travel path traversed by the movable device in response to losing a control signal; and
controlling the movable device to travel based on the topology information and searching for the control signal.

2. The method of claim 1, prior to losing the control signal, the method further comprises controlling the movable device to travel based on the control signal and establishing the topology information.

3. The method of claim 2, wherein the topology information comprises vertices and legs, wherein a vertex represents a location at which the movable device arrived, and a leg represents a line connecting two vertices.

4. The method of claim 3, wherein establishing the topology information comprises:
establishing an initial vertex based on an initial travel location of the movable device; and
establishing a new vertex and a new leg based on an influence region of a vertex that has been established, wherein the influence region is a predetermined region having the vertex as a center point.

5. The method of claim 4, wherein establishing the topology information comprises:
deleting an oldest vertex and one or more legs connected with the oldest vertex prior to establishing the new vertex, based on a determination that a number of the vertices included in the topology information has reached a predetermined value.

6. The method of claim 1, wherein controlling the movable device to travel based on the topology information comprises:
determining the travel path based on the topology information;
controlling the movable device to travel along the travel path,
wherein the travel path satisfies at least one of the following:
the travel path is the shortest;
a cost associated with the traveling along the travel path is the lowest; or
the travel path leads to a returning point, the returning point representing a starting point of the movable device or representing a predetermined return location.

7. The method of claim 3, wherein the topology information comprises the vertices and the legs, and controlling the movable device to travel based on the topology information comprises:
selecting a leg from a plurality of legs connected to a current vertex based on the topology information; and
controlling the movable device to travel based on the selected leg.

8. The method of claim 7, wherein the selected leg is a leg connecting the current vertex and a vertex that the movable device last travelled by.

9. The method of claim 7, wherein the selected leg is a leg connecting the current vertex and a vertex that is closest to a returning point, wherein the returning point indicates a starting point of the movable device or a predetermined returning location.

10. The method of claim 1, further comprising:
terminating the searching for the control signal when at least one of the following is satisfied:
the control signal is detected during the searching;
the topology information has been deleted;
an abnormal condition occurred in a system of the movable device;
the movable device cannot travel based on the topology information; or
the searching for the control signal has been performed a predetermined number of times.

11. A movable device, comprising:
a memory configured to store computer-executable instructions; and
a processor configured to execute the computer-executable instructions to:
obtain topology information of a travel path traversed by the movable device in response to losing a control signal;
control the movable device to travel based on the topology information; and
search for the control signal while the movement device controls the movable device to travel based on the topology information.

12. The movable device of claim 11, wherein the processor is further configured to execute the computer-executable instructions to:
establish the topology information prior to losing the control signal.

13. The movable device of claim 11, wherein the topology information comprises vertices and legs, wherein a vertex represents a location at which the movable device arrived, and a leg represents a line connecting two vertices.

14. The movable device of claim 13, wherein the processor is further configured to execute the computer-executable instructions to:
establish an initial vertex based on an initial travel location of the movable device; and
establish a new vertex and a new leg based on an influence region of a vertex that has been established, wherein the influence region is a predetermined region having the vertex as a center point.

15. The movable device of claim 13, wherein the processor is further configured to execute the computer-executable instructions to:
delete an oldest vertex and one or more legs connected with the oldest vertex prior to establishing a new vertex, based on a determination that a number of vertices included in the topology information has reached a predetermined value.

16. The movable device of claim 11, wherein the processor is further configured to execute the computer-executable instructions to:
determine the travel path based on the topology information; and
control the movable device to travel along the travel path, wherein the travel path satisfies at least one of the following:
the travel path is the shortest;
a cost associated with the traveling along the travel path is the lowest; or
the travel path leads to a returning point, the returning point representing a starting point of the movable device or representing a predetermined return location.

17. The movable device of claim 11, wherein the processor is further configured to execute the computer-executable instructions to:
select a leg from a plurality of legs connected to a current vertex based on the topology information that comprises vertices and legs; and
control the movable device to travel based on the selected leg.

18. The movable device of claim 17, wherein the selected leg is a leg connecting the current vertex and a vertex that the movable device last travelled by.

19. The movable device of claim 17, wherein the selected leg is a leg connecting the current vertex and a vertex that is closest to a returning point, wherein the returning point indicates a starting point of the movable device or a predetermined returning location.

20. The movable device of claim 17, wherein the processor is further configured to execute the computer-executable instructions to:
terminate the search for the control signal when at least one of the following is satisfied:
the control signal is detected during the search;
the topology information has been deleted;
an abnormal condition occurred in a system of the movable device;
the movable device cannot travel based on the topology information; or
the search for the control signal has been performed a predetermined number of times.

21. A movable device, comprising:
a propulsion system; and
a control system, comprising:
a storage device configured to store computer-executable instructions; and
a processor configured to access the storage device and execute the computer-executable instructions to perform a method for controlling the movable device, the method comprising:
obtaining topology information of a travel path traversed by the movable device in response to losing a control signal; and
controlling the movable device to travel based on the topology information and searching for the control signal.
